(19) United States
(12) Patent Application Publication
(10) Pub. No.: US 2020/0146271 A1
(43) Pub. Date: May 14, 2020

(54) Fish Hook Setting Device

(71) Applicant: Ronald Gallegos, Denver, CO (US)

(72) Inventor: Ronald Gallegos, Denver, CO (US)

(21) Appl. No.: 16/190,567

(22) Filed: Nov. 14, 2018

(51) Int. Cl. A01K 97/10; A01K 97/01

(52) U.S. Cl. CPC A01K 97/10; A01K 97/01

(57) ABSTRACT

A fish hook setting device for automatically setting a fish hook includes a tube, which has a top that is open so that the tube is configured to insert a handle of a fishing rod. A stake that is coupled to a bottom of the tube is configured to insert into ice proximate to a fishing hole. A line is coupled to and extends from the tube proximate to the bottom. A coupler that is coupled to the line distal from the tube is configured to removably couple to a guide at a tip of the fishing rod, reversibly positioning the fishing rod is in a tensioned configuration. A strike on a hook that is coupled a fishing line of the fishing rod induces the coupler to decouple from the guide at the tip, wherein the fishing rod resumes a linear configuration so that the hook is set.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

(1) Field of the Invention.

(2) Description of Related Art including information disclosed under 37 CFR 1.97 and 1.98.

The disclosure and prior art relate to setting devices and more particularly pertain to a new setting device for automatically setting a fish hook.

### (h) BRIEF SUMMARY OF THE INVENTION

An embodiment of the disclosure meets the needs presented above by generally comprising a tube, which has a top that is open so that the tube is configured to insert a handle of a fishing rod. A stake that is coupled to a bottom of the tube is configured to insert into ice proximate to a fishing hole. A line is coupled to and extends from the tube proximate to the bottom. A coupler that is coupled to the line distal from the tube is configured to removably couple to a guide at a tip of the fishing rod, reversibly positioning the fishing rod is in a tensioned configuration. A strike on a hook that is coupled a fishing line of the fishing rod induces the coupler to decouple from the guide at the tip, wherein the fishing rod resumes a linear configuration so that the hook is set.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a fish hook setting device according to an embodiment of the disclosure.

FIG. 2 is a side view of an embodiment of the disclosure.

FIG. 3 is a bottom view of an embodiment of the disclosure.

FIG. 4 is an in-use view of an embodiment of the disclosure.

### DETAILED DESCRIPTION OF THE INVENTION

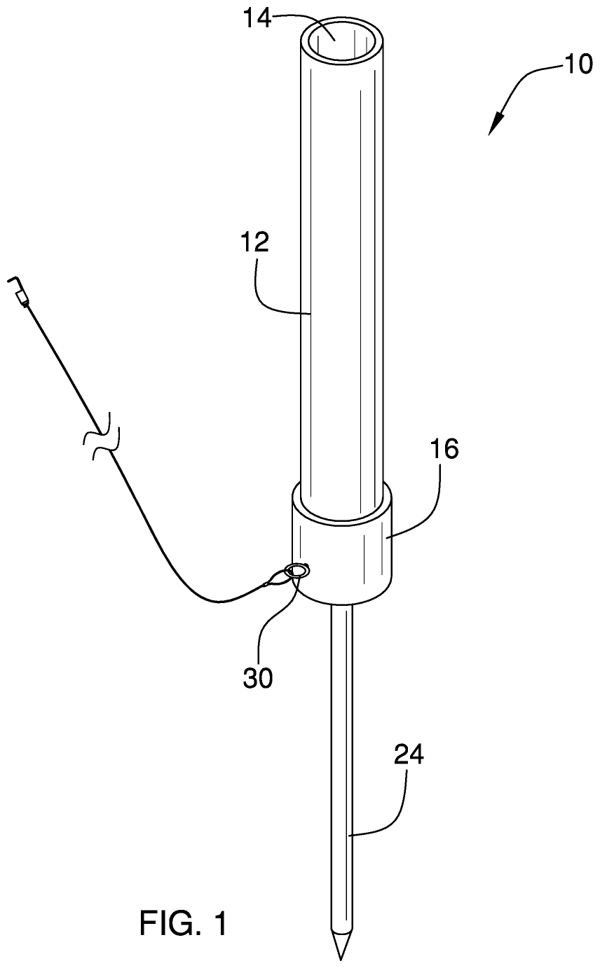

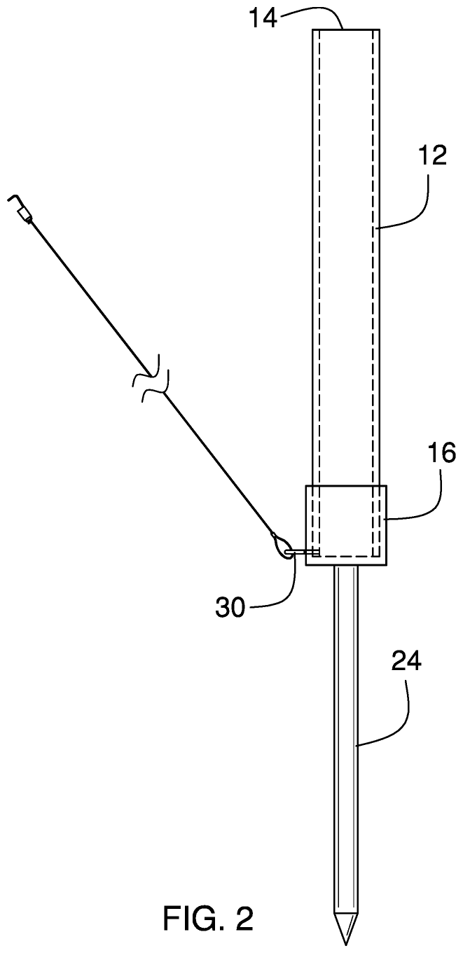

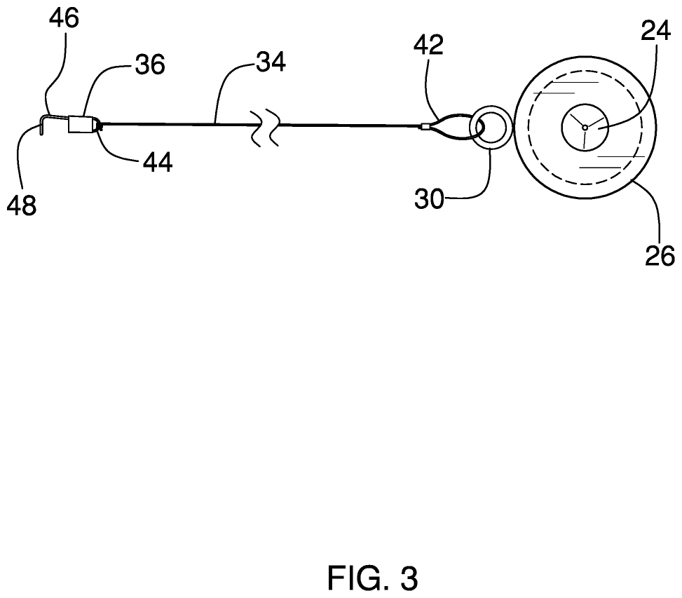

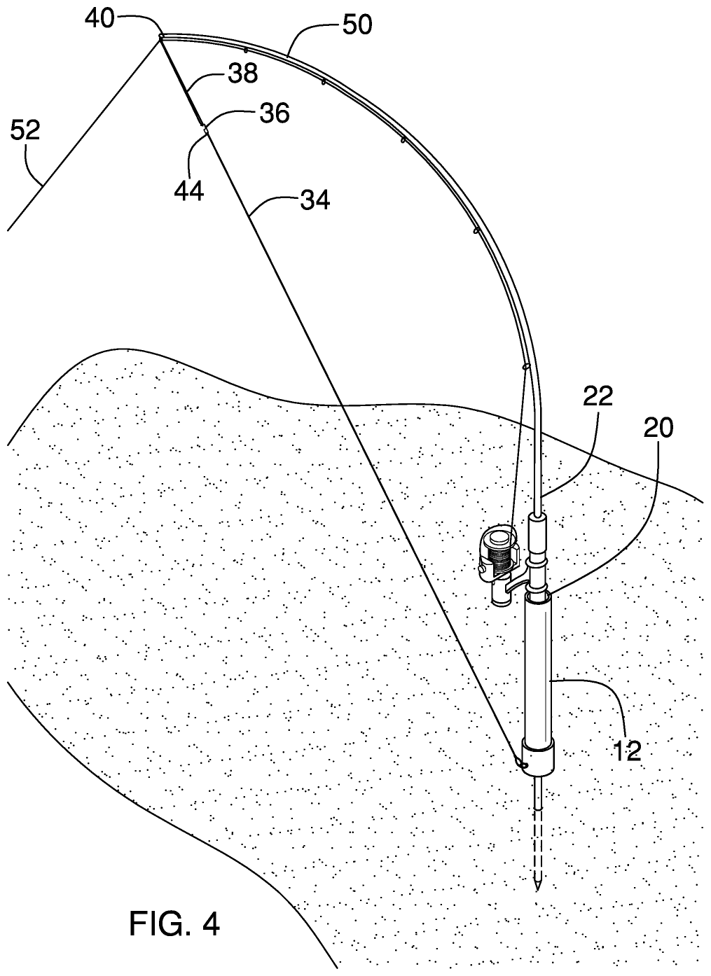

With reference now to the drawings, and in particular to FIGS. 1 through 4 thereof, a new setting device embodying the principles and concepts of an embodiment of the disclosure and generally designated by the reference numeral 10 will be described.

As best illustrated in FIGS. 1 through 4, the fish hook setting device 10 generally comprises a tube 12, a stake 14, a line 16, and a coupler 40. The tube 12 has a top 18 that is open and a bottom 20 that is closed. The tube 12 is configured to insert a handle 22 of a fishing rod 24. The tube 12 is circularly shaped when viewed longitudinally. The tube 12 comprises polyvinylchloride.

The stake 14 is coupled to and extends from the bottom 20 of the tube 12. The stake 14 is configured to insert into ice proximate to a fishing hole in the ice to position a guide 26 at a tip 28 of the fishing rod 24 over the fishing hole.

A rod 32 is coupled to and extends bidirectionally from the tube 12 proximate to the bottom 20. The rod 32 is configured to be grasped in hands of a user to insert the stake 14 into the ice proximate to the fishing hole in the ice.

The line 16 is coupled to and extends from the tube 12 proximate to the bottom 20. The line 16 is dimensionally shorter than the fishing rod 24. The line 16 comprises steel cable. The line 16 has a first end 34 that is coupled to the line 16 proximate to the first end 34 to define a loop 36. An eyelet 38 is coupled to the tube 12 proximate to the bottom 20. The loop 36 is positioned through the eyelet 38 so that the line 16 is coupled to the eyelet.

The coupler 40 is coupled to the line 16 distal from the tube 12. The coupler 40 is configured to removably couple to the guide 26 at the tip 28 of the fishing rod 24 so that the fishing rod 24 is reversibly positioned in a curved and tensioned configuration. A strike on a hook that is coupled to an end of a fishing line of the fishing rod 24 induces the coupler 40 to decouple from the guide 26 at the tip 28, causing the fishing rod 24 to rapidly resume a linear configuration so that the hook is set. The coupler 40 comprises a wire 42 that is curved so that the wire 42 is configured to hook to the guide 26 at the tip 28.

In use, the user utilizes the rod 32 to insert the stake 14 into the ice proximate to the fishing hole. The user would then attach bait to the hook and drop the bait and fishing line into the water. The user the bends the fishing rod 24 downward and attaches the coupler 40 to the guide 26 at the tip 28 of the fishing rod 24 so that the fishing rod 24 is reversibly positioned in the curved and tensioned configuration. When a fish strikes the hook and pulls on the fishing line, it releases the coupler 40 and causes the fishing rod 24 to rapidly resume the linear configuration so that the hook is set in the fish's mouth. The user could then remove the fishing rod 24 from the tube 12 and reel the fish to the surface.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded.

A reference to an element by the indefinite article “a” does not exclude the possibility that more than one of the elements is present, unless the context clearly requires that there be only one of the elements.

I claim:

1. A fish hook setting device comprising:
a tube, the tube having a top and a bottom, the top being open, the bottom being closed wherein the tube is configured for inserting a handle of a fishing rod;
a stake coupled to and extending from the bottom of the tube wherein the stake is configured for inserting into ice proximate to a fishing hole in the ice for positioning a guide at a tip of the fishing rod over the fishing hole;
a line coupled to and extending from the tube proximate to the bottom, the line being dimensionally shorter than the fishing rod; and
a coupler coupled to the line distal from the tube, the coupler being configured for removably coupling to the guide at the tip of the fishing rod such that the fishing rod is reversibly positioned in a curved and tensioned configuration such that a strike on a hook coupled to an end of a fishing line of the fishing rod induces the coupler for decoupling from the guide at the tip causing the fishing rod to rapidly resume a linear configuration such that the hook is set.

2. The device of claim 1, further including the tube being circularly shaped when viewed longitudinally.

3. The device of claim 1, further including the tube comprising polyvinylchloride.

4. The device of claim 1, further including the line comprising steel cable.

5. The device of claim 1, further including the coupler comprising a wire, the wire being curved such that the wire is configured for hooking to the guide at the tip.

6. The device of claim 1, further comprising:
the line having a first end coupled to the line proximate to the first end defining a loop; and
an eyelet coupled to the tube proximate to the bottom, the loop being position through the eyelet such that the line is coupled to the eyelet.

7. The device of claim 1, further including a rod coupled to and extending bidirectionally from the tube proximate to the bottom wherein the rod is configured for grasping in hands of a user for inserting the stake into the ice proximate to the fishing hole in the ice.

8. A fish hook setting device and fishing rod combination comprising:
a fishing rod;
a tube, the tube having a top and a bottom, the top being open, the bottom being closed wherein the tube is positioned for inserting a handle of the fishing rod;
a stake coupled to and extending from the bottom of the tube wherein the stake is configured for inserting into ice proximate to a fishing hole in the ice for positioning a guide at a tip of the fishing rod over the fishing hole;
a line coupled to and extending from the tube proximate to the bottom, the line being dimensionally shorter than the fishing rod; and
a coupler coupled to the line distal from the tube, the coupler being positioned for removably coupling to the guide at the tip of the fishing rod such that the fishing rod is reversibly positioned in a curved and tensioned configuration such that a strike on a hook coupled to an end of a fishing line of the fishing rod induces the coupler for decoupling from the guide at the tip causing the fishing rod to rapidly resume a linear configuration such that the hook is set.

9. A fish hook setting device comprising:
a tube, the tube having a top and a bottom, the top being open, the bottom being closed wherein the tube is configured for inserting a handle of a fishing rod, the tube being circularly shaped when viewed longitudinally, the tube comprising polyvinylchloride;
a stake coupled to and extending from the bottom of the tube wherein the stake is configured for inserting into ice proximate to a fishing hole in the ice for positioning a guide at a tip of the fishing rod over the fishing hole;
a line coupled to and extending from the tube proximate to the bottom, the line being dimensionally shorter than the fishing rod, the line comprising steel cable, the line having a first end coupled to the line proximate to the first end defining a loop;
a coupler coupled to the line distal from the tube, the coupler being configured for removably coupling to the guide at the tip of the fishing rod such that the fishing rod is reversibly positioned in a curved and tensioned configuration such that a strike on a hook coupled to an end of a fishing line of the fishing rod induces the coupler for decoupling from the guide at the tip causing the fishing rod to rapidly resume a linear configuration such that the hook is set, the coupler comprising a wire, the wire being curved such that the wire is configured for hooking to the guide at the tip;
an eyelet coupled to the tube proximate to the bottom, the loop being position through the eyelet such that the line is coupled to the eyelet; and
a rod coupled to and extending bidirectionally from the tube proximate to the bottom wherein the rod is configured for grasping in hands of a user for inserting the stake into the ice proximate to the fishing hole in the ice.
